(19) United States
(12) Patent Application Publication
(10) Pub. No.: US 2003/0029507 A1
(43) Pub. Date: Feb. 13, 2003

(54) Fluid discharge floodgate improved for cistern aircrafts dedicated to fight fires

(76) Inventors: Rafael Delgado Zafra, Cordoba (ES); Fernando Espejo Delgado, Cordoba (ES)

Correspondence Address: PENDORF & CUTLIFF, P.O. Box 20445, Tampa, FL, 33622-0445, US

(21) Appl. No.: 10/217,192

(22) Filed: Aug. 12, 2002

(30) Foreign Application Priority Data
Aug. 10, 2001 (ES) 200101884

(51) Int. Cl. F16K 31/00

(52) U.S. Cl. 137/601.01

(57) ABSTRACT

A fluid discharge floodgate improved for cistern aircrafts dedicated to fight fires comprising a first door, which opens toward an outside of the aircraft, and a second door that opens toward the interior of the aircraft. The first door and the second door are interconnected by a first rod, and a first lever and the combination of the first rod and the first lever forces the doors to open in opposite directions.

### OBJECT OF THE INVENTION

The present description refers to a request for a patent of invention, pertaining to a fluid discharge floodgate improved for cistern aircrafts dedicated to fight fires, whose purpose rest in permitting the floodgate to be operated electronically, manually or pneumatically.

When the discharge of the floodgate is electronically controlled, several partial discharges of the content of the fluid tank or hopper can be performed, at the same time the complete discharge with the totally open doors can be carried out, the complete discharge with controlled flow can be carried out, as well as several discharges with controlled flow at the discretion of the aircraft pilot.

### FIELD OF THE INVENTION

This invention has its application in the industry dedicated to the production of apparatuses, devices, and auxiliary elements for cistern aircrafts.

### BACKGROUND OF THE INVENTION

The present inventor knows many types of discharge floodgates for cistern aircrafts, which exhibit many mechanical and operating disadvantages such as controlling the discharge of the fluid transported in the aircraft.

The most utilized floodgate in cistern aircrafts dedicated to fire extinction is the one known as “one discharge,” which operates by opening the floodgate by gravity action and does not have closing means.

Also, it has been established that the cistern aircraft pilots do not have the possibility of controlling the content of the cistern, with the purpose of dividing the total fluid transported, or to control the outflow of the transported fluid.

The present inventor also knows other types of fluid discharge floodgates for cistern aircrafts that can divide the transported fluid in several discharges and even control the outflow of the transported fluid. The present inventor established that all these discharge floodgates present a common disadvantage. The disadvantage is that these floodgates, or individual doors of the floodgate, are opened toward the outside of the aircraft, in favor of the pressure exercised by the transported fluid, and close against the flow of the fluid, which requires the need of powerful devices to defeat the pressure of the fluid that flows out of the cistern or hopper. In addition, depending on the velocity and the maneuvers of the aircraft, the fluid weight can be multiplied from 1 to 2.5, because of the positive increase of gravity originated by the acceleration of the aircraft ascent generated by its loss of weight during the partial discharge of the transported fluid.

In summary, the majority of the fluids discharge floodgates for cistern aircrafts dedicated to fight fires utilized at the present, are configured like floodgates of only one discharge and without flow control, or closure, while the ones that permit several discharges by incorporating a flow control, need to use very powerful devices for the closing of the floodgates during a partial discharge because of the disposition of the gates, requiring the employment of pistons or hydraulic motors.

The solution to the existing problem in this serious matter is to be able to count on an invention which overcomes the problem indicated previously, permitting the partial or total execution of discharges with control of flow, which do not require the presence of the cited devices of great power to collaborate in the closing of the floodgates when a partial discharge is performed.

However, until now, the present inventor does not have knowledge of the existence of a suitable invention that present the characteristics indicated previously.

### DESCRIPTION OF THE INVENTION

The improved fluid discharge floodgate for cistern aircrafts dedicated to fight fires, according to the present invention, configures itself as novel inside its specific application field, since the present invention contemplates a plurality of technical solutions that simplify and improve the fluid discharge floodgates for cisterns aircrafts.

In a more concrete way, the improved fluid discharge floodgate for cistern aircrafts dedicated to fight fires, which is an object of the present invention, consists of a hydraulic device that is configured as the primary system for opening and closing the floodgates, which is comprised of a pressure unit, including a pressure and flow pump, a hydraulic reservoir capable of storing the quantity of flow required, as well as of the relevant pressure to perform maneuvers for opening and closing the doors, a hydraulic cylinder with a plurality of gears to be utilized for reducing or multiplying the movement of the levers axes and a set of electric valves controlled by a electronic station that detects the position of the floodgates through some beam sensors.

The invention includes mechanical means for the manual operation, and also includes emergency auxiliary means configured as pneumatic instruments, which are operated by the pilot from the cabin by utilizing a lever.

The floodgate is installed in the lower part of the fluid cistern, deposit, or hopper in the cistern aircraft, and comprises of two combined doors, in which one of the doors opens toward the outside, helped by the pressure exercised by the fluid stored in the cistern or hopper, and the other door opens toward the interior, against the pressure generated by the fluid.

The first door, the one that opens toward the outside, is operated by the action performed upon a lever through a rod, both doors being interconnected by means of a rod and a lever, which have the mission of forcing the doors to move in opposite directions.

The combination described above, upon the doors that generate the opening or closing in opposite ways in relation to the pressure of fluid, favors both the maneuver of opening and that of closing, since the two doors are of the same surface area, the force created by the pressure of the fluid remains in equilibrium between the two doors.

The combination of the lever and rod generate the blockade of the closed doors by the effect of “point defeated” or “point of no return.”

All the materials utilized in the production of the door, which are in contact with the fluids, need to be corrosion resistant materials, such as stainless steel, plastic, rubber, or any other suitable elastomeric.

### DESCRIPTION OF THE DRAWINGS

To complement the present description and with the purpose of helping a better comprehension of the characteristics of this invention, the present description is provided, as an integrated part of the same, with a set of drawings which are presented for illustration and not limiting purposes, the following is presented:

FIG. 1—is a front sectional view according to the present invention, relative to a fluid discharge floodgate improved for cistern aircrafts dedicated to fight fires showing the floodgate in a closed position.

FIG. 2—represents a similar view shown in FIG. 1, with the doors partially open.

FIG. 3—corresponds to a view of the doors represented in previous figures, totally open.

FIG. 4—shows in detail the mechanism.

FIG. 5—is a perspective view of one of the doors.

FIG. 6—is a diagram view of the hydraulic system for operating the discharge floodgate.

### PREFERRED EMBODIMENT

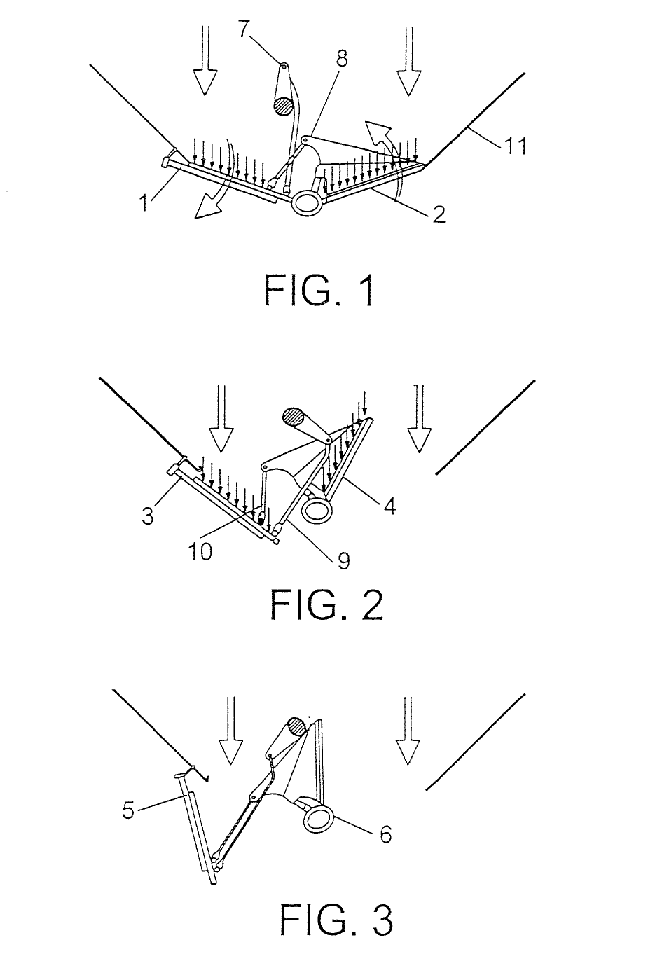

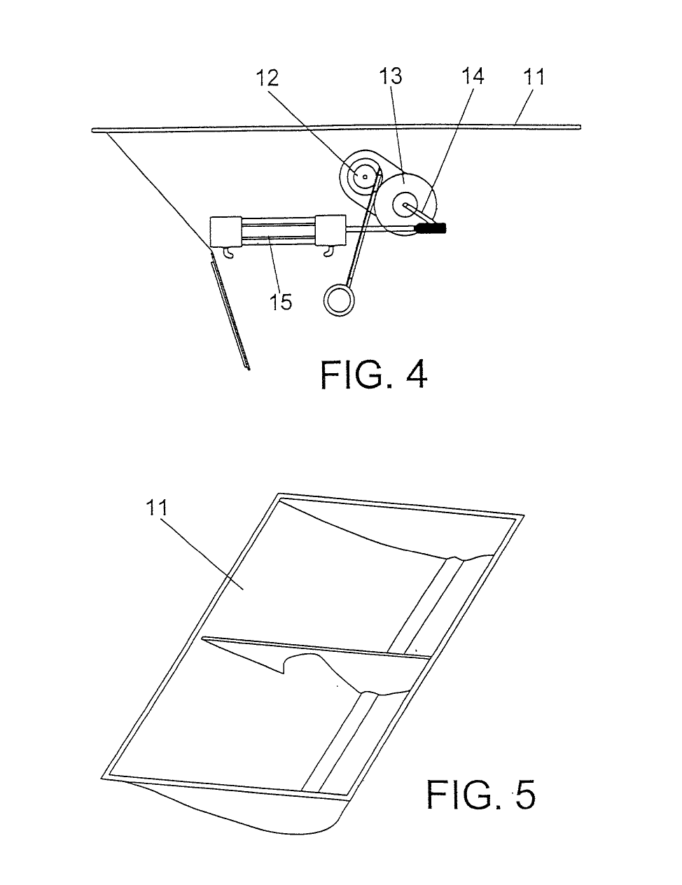

Looking at FIGS. 1, 2, 3, 4, and 5, it can be observed, how the improved fluids discharge floodgate for cistern aircrafts dedicated to fight fires comprises of a stainless steel metallic structure (11) which accommodates two doors (1) and (2), as well as the lever (7), rods (9) and (10), gears (12) and (13), incorporating a cylinder or actuator motor (15) and the necessary mechanisms to combine the movements of opening and closing.

The operation of the invention consists on the fact that upon receiving the cylinder or motor (15), the pertinent hydraulic pressure, the lever (14) drives the attached gear (13), and this gear (13) operates a second gear (12) that has the purpose of reversing the direction of the rotation, and this gear (12) attached to the lever (7) which transmits the movement to the door (2) from the door (1).

For security, the floodgate can utilize two different systems of operation, one in each extreme of the lever axis (7), having different sources of power, such as hydraulic, pneumatics, or electric, with the purpose of preventing the breakdown of the floodgate due to the failure of a system of operation.

The present invention also includes a mechanical emergency system that consists of a lever situated in the cabin of the aircraft, which when it is operated by the pilot, it drives the lever by the traction of a command cable, which at the same time, drags the other lever, which generates the mobilization of the axes of the floodgate hinges, one that opens toward the outside and unhooks the door (1) from the hinge remaining consequently opened by the pressure generated by the volume of the fluid transported as well as by its weight.

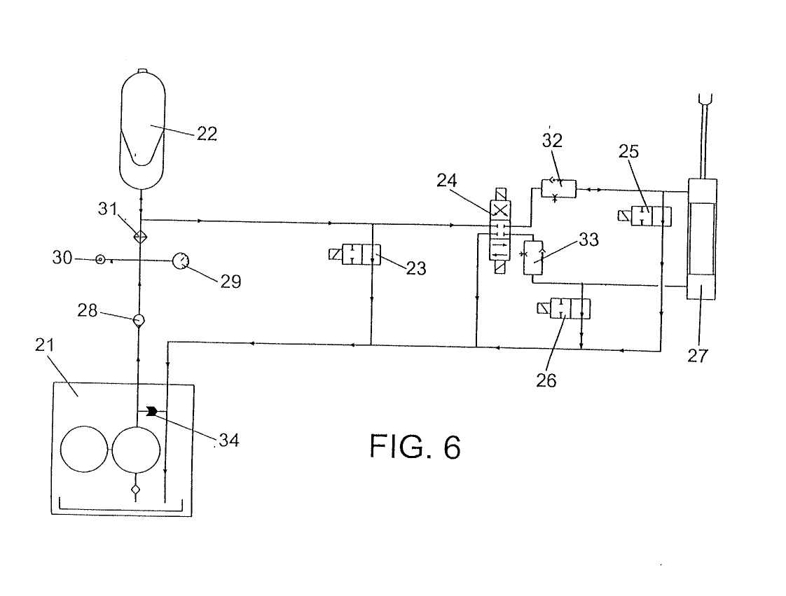

The invention presents a primary hydraulic assembly, represented in FIG. 6, constituted of an electric pump or hydraulic unit of power (21), an anti-return or check valve (28), a hydraulic reservoir or collector (22), an electric control valve (24), for the capture and closure, an actuator (27) or piston or hydraulic motor, an electric bleeding valve (23) for the pressure of the hydraulic collector (22) and two emergency electric valves (25) and (26) which relieve the pressure of the actuator (27) or piston or hydraulic motor in case of emergency, to be able to open the doors by other means.

It should be indicated, that once the electric system is energized, it supplies electric voltage to the hydraulic pressure unit (21) or pump through the starter relay activated by the pressure switch (30), the hydraulic power unit (21) supplying hydraulic fluid to the collector (22) through the check valve (28) until the pressure switch (30) pre-selected pressure is achieved set to approximately 175 bars, supplying the hydraulic unit of pressure (21) the hydraulic flow according to its demand, through the pressure switch (30) that maintains the system inside the margins of pressure, using a filter (31) and incorporating in the hydraulic power unit or pump (21) with a relief valve (34).

The electric control valve (24) is responsible for operating the cylinder of the actuator motor in the direction of opening or closing through the flow control valves (32) and (33) which permit the adjustment of the maneuver velocity, by driving the electric bleeding valve (23) for discharging the pressure system when the electric system is disconnected and the emergency electric valves (25) and (26) connecting the lines of the cylinder or motor actuator to the return line in order that the floodgates could be opened by another system in case of failure of the primary hydraulic system.

The hydraulic power unit, according to the present invention, contains a relief valve set to 175 bars to prevent a possible overpressure in case the pressure switch (30) fails.

The primary electronic command can utilize an electronic control that acts with a direct current between 24 and 28 volts.

What I claim is:

1. A fluid discharge floodgate improved for cistern aircrafts dedicated to fight fires, the floodgate installed in the lower part of the fluid cistern, deposit or hopper in the cistern aircraft, and comprises two combined doors (1) and (2), the door (1) opens toward the outside and the door (2) opens toward the interior, the door being operated by the action performed upon a lever (7) through a rod (9), both doors (1) and (2) being interconnected by means of a rod (10) and a lever (8), the doors (1) and (2) move in opposite directions, the combination of the lever (7) and rod (9) generates the blockade of the closed doors (1) and (2), all the elements of the doors and the mechanism being manufactured in stainless steel, plastic and elastomeric.

2. A fluid discharge floodgate improved for cistern aircrafts dedicated to fight fires, according to the first claim, characterized because the floodgate is formed by a stainless steel metallic structure (11), which accommodates the two doors (1) and (2), as well as to the lever (7), rods (9) and (10), gear (12) and (13), incorporating a cylinder or actuator motor (15) and other elements.

3. A fluids discharge floodgate improved for cistern aircrafts dedicated to fight fires, according to the previous claims, characterized by having a primary hydraulic assembly having an electric pump (21), an anti-return valve (28), a hydraulic reservoir or collector (22), an electric control valve (24), an actuator (27) or piston or hydraulic motor, an electric bleeding valve (23) for the pressure of the hydraulic collector (22) and two emergency electric valves (25) and (26).

4. A fluid discharge floodgate improved for cistern aircrafts dedicated to fight fires, according to the third claim, characterized because the hydraulic pressure unit (21) is energized through the starter relay activated by the low pressure switch (30), the hydraulic power unit (21) supplies fluid to the collector (22) through the anti-return valve (28) until the pressure switch (30) pre-selected pressure is achieved set to approximately 175 bars, the hydraulic pressure unit (21) supplies the hydraulic flow through the pressure switch (30) that maintains the primary assembly of hydraulic operation inside some pre-adjusted margins of pressure.

5. A fluid discharge floodgate improved for cistern aircrafts dedicated to fight fires, according to the fourth claim, characterized because the electric control valve (24) operates the cylinder of the actuator motor in the direction of opening and closing through the flow control valves (32) and (33) which permit the adjustment of the maneuver velocity, by driving the electric bleeding valve (23) for discharging the pressure system when the electric system is disconnected and the emergency electric valves (25) and (26) connecting the lines of the cylinder or actuator motor to the return line in order that floodgates could be opened by other systems in case of failure of the primary system.

6. A fluid discharge floodgate improved for cistern aircrafts dedicated to fight fires, according to the previous claims, characterized by having a relief valve (34) set at 175 bars in the hydraulic power unit.
